(19) United States
(12) Patent Application Publication
(10) Pub. No.: US 2026/0187496 A1
(43) Pub. Date: Jul. 2, 2026

(54) SYSTEM AND METHOD FOR AI-DRIVEN VISUALIZATION, MATCHING, AND ACCESS TO DISTRIBUTED VISUAL INNOVATION ASSETS AND RESOURCES

(71) Applicant: Tanice Tricia Kaye Gonsalves, Alexandria, VA (US)

(72) Inventor: Tanice Tricia Kaye Gonsalves, Alexandria, VA (US)

(21) Appl. No.: 19/542,915

(22) Filed: Feb. 18, 2026

Related U.S. Application Data
(60) Provisional application No. 63/735,378, filed on Dec. 18, 2024.

(51) Int. Cl. G06N 5/022; G06F 16/904

(52) U.S. Cl. CPC G06N 5/022; G06F 16/904

(57) ABSTRACT

A computer-implemented system and method are disclosed for providing AI-driven visualization and access to distributed innovation resources. Innovation-related data from multiple sources is processed using artificial intelligence models to generate structured representations. An interactive visual interface enables dynamic exploration and matching of innovation resources to user-defined objectives, improving discovery, access, and deployment of innovation assets.

### CROSS-REFERENCE TO RELATED APPLICATION

This application claims priority to U.S. Provisional Patent Application No. 63/735,378, filed on Dec. 18, 2024, the entire contents of which are hereby incorporated by reference in their entirety for all purposes.

### FIELD OF THE INVENTION

The present invention relates generally to artificial intelligence, distributed computing, and interactive visualization systems, and more particularly to computer-implemented systems and methods for discovering, visualizing, matching, and accessing distributed innovation assets and resources using artificial intelligence models and adaptive visual interfaces. This invention will Transform Global Innovation Access and Deliver Global Innovation worlds as a service. This invention will allow users to see innovation in a Visualplace.

### BACKGROUND OF THE INVENTION

Innovation assets such as technical solutions, intellectual property, research outputs, proprietary know-how, and subject-matter expertise are commonly distributed across independent organizations, databases, repositories, and networks. These assets are typically managed in heterogeneous formats, governed by disparate access controls, and isolated within siloed systems.

Existing innovation discovery platforms rely primarily on keyword-based search, manual curation, or static taxonomies, which are ill-suited for identifying relevant innovation resources in response to complex or evolving objectives. Such systems lack the capability to transform unstructured or semi-structured innovation data into machine-interpretable representations that support real-time comparison, contextual reasoning, and intelligent routing.

Furthermore, conventional systems do not provide interactive, adaptive visualization mechanisms capable of exposing relationships between innovation assets, assessing readiness or compatibility, or dynamically refining discovery based on user interaction. As a result, identifying, accessing, and deploying innovation assets remains inefficient, time-consuming, and constrained by rigid data models.

Accordingly, there exists a need for an AI-driven system that can ingest distributed innovation data, generate structured representations, dynamically match resources to objectives, and present results through an interactive visual interface that supports exploration, decision-making, and deployment.

### SUMMARY OF THE INVENTION

The present invention provides a computer-implemented system and method for AI-driven visualization, discovery, matching, and access to distributed innovation resources.

In one embodiment, the system ingests innovation-related data from a plurality of independently managed sources and applies one or more artificial intelligence models to transform the data into structured representations suitable for comparison, ranking, and visualization. An interactive visual interface presents the structured innovation resources and enables users to dynamically explore relationships, refine objectives, and access selected resources.

The system supports visualization, routing, and deployment of innovation solutions and enables dynamic AI-based discovery and allocation of innovation resources in response to user-defined objectives.

The system further supports the identification of users related to innovation solutions and facilitates inter-user communication and networking via AI-based discovery and recommendations based on role and relationship to the innovation solutions and the solution provider.

In various embodiments, the invention may be implemented as:
a system,
a method, and/or
a non-transitory computer-readable medium storing instructions that cause one or more processors to perform the disclosed functionality.

Advantages include:
Transformation of heterogeneous innovation data into structured, machine-interpretable representations
AI-driven matching of innovation objectives to distributed resources
Interactive visualization enabling real-time exploration and refinement
Continuous learning through user feedback
Scalable deployment across cloud, distributed, or edge computing environments
Unified access to independently managed innovation providers
Improved discovery, engagement, and deployment of innovation assets
Visualized Innovation that allows the showcasing of innovation assets
AI-Facilitated promotion of multi-channel user communication through user attributes, interests, and role
Innovation assets matched to Innovation resources in one single system

The foregoing and other features and advantages of the invention will become further apparent from the following detailed description of the presently preferred embodiments, read in conjunction with the accompanying drawings.

### BRIEF DESCRIPTION OF THE DRAWINGS

The accompanying drawings, which are incorporated in and constitute a part of this specification, illustrate presently preferred embodiments of the invention and, together with the detailed description, serve to explain the principles of the invention.

FIG. 1 illustrates an innovation platform architecture showing data ingestion from external databases and social networks, processing through analytics networks and an analytics engine, generation of recommendations through a recommendation engine, visualization through a visualization engine and visualization systems, and presentation through a user interface;

FIG. 2 illustrates a data flow from multiple data sources through ingestion, normalization, preprocessing, to knowledge graph construction and embeddings generation;

FIG. 3 illustrates a machine learning model training pipeline showing training data input, normalization and preprocessing, embeddings generation, and trained engine output;

FIG. 4 illustrates a method flowchart showing the sequential steps of collecting innovation data, normalizing and processing data, analyzing and classifying information, and generating recommendations;

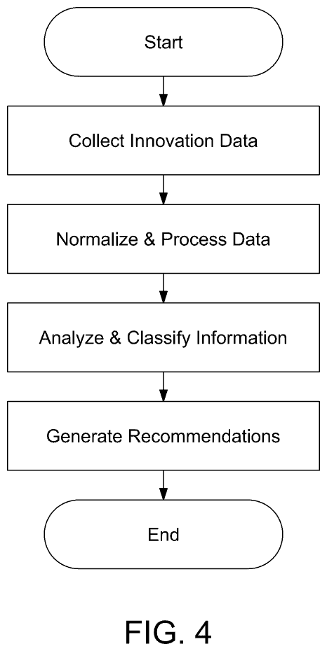

FIG. 5 illustrates an interactive user interface featuring network visualization, search functionality, filters, innovation networks display, and matched innovation results;

FIG. 6 illustrates social media data analysis showing connections between influencers, organizations, and professional networks with sentiment and trend analysis capabilities;

FIG. 7 illustrates user behavior signal capture and feedback into a machine learning loop; and

FIG. 8 illustrates an end-to-end innovation lifecycle from ingestion to user objective fulfillment.

### DETAILED DESCRIPTION OF THE INVENTION

The present invention will now be described more fully hereinafter with reference to the accompanying drawings, in which preferred embodiments of the invention are shown. This invention, however, may be embodied in many different forms and should not be construed as limited to the embodiments set forth herein. Rather, these embodiments are provided so that this disclosure will be thorough and complete, and will fully convey the scope of the invention to those skilled in the art. As used herein, the term “comprising” means including but not limited to, and should be interpreted in the manner it is typically used in the patent context. The phrases “in one embodiment,” “according to one embodiment,” and the like generally mean that the particular feature, structure, or characteristic following the phrase may be included in at least one embodiment of the present invention, and may be included in more than one embodiment of the present invention (importantly, such phrases do not necessarily refer to the same embodiment).

The term “government agency” or “governmental entity” as used herein refers to federal, state, local, or other governmental organizations, departments, bureaus, or entities involved in procurement activities. The term “technology company” refers to businesses, enterprises, or organizations that provide technology-related products, services, solutions, or capabilities. The term “real-time” refers to interactions, communications, or processes that occur with minimal delay, enabling substantially immediate exchange of information between parties.

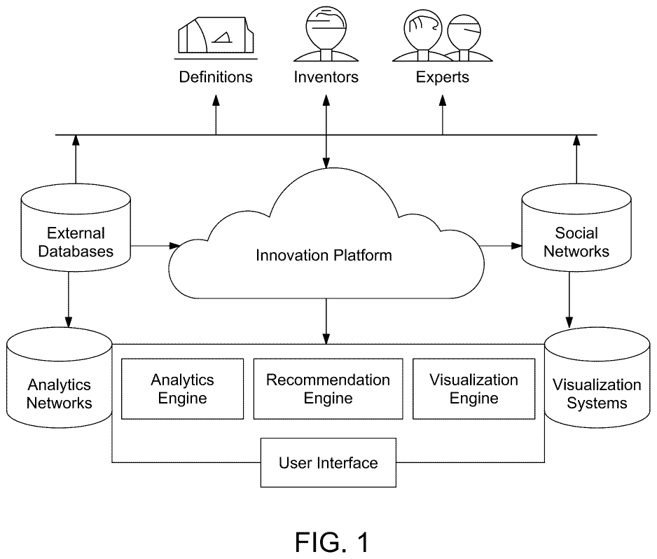

### System Architecture (FIG. 1)

Referring to FIG. 1, the visual innovation platform architecture comprises external data sources (including external databases and social networks), an analytics engine for processing and analyzing data, a recommendation engine for matching objectives to resources, a visualization engine for generating visual representations, and a user interface through which users interact with visualization systems.

In various implementations, the system comprises one or more computing devices including processors and memory, and includes
Data Ingestion Module(s) configured to collect innovation-related data from distributed sources, including databases, APIs, repositories, and networks;
Feature Extraction Engine configured to normalize, encode, and preprocess the ingested data;
Machine Learning Models configured to generate structured representations of innovation resources;
Model Orchestration Layer configured to manage model selection, execution, versioning, and updates;
Inference and Matching Engine configured to match innovation objectives with relevant resources;
Visualization Interface configured to present interactive visual representations of innovation assets; and
Feedback Loop configured to capture user interaction data and update model parameters.

The system may operate in a centralized, distributed, or hybrid computing architecture.

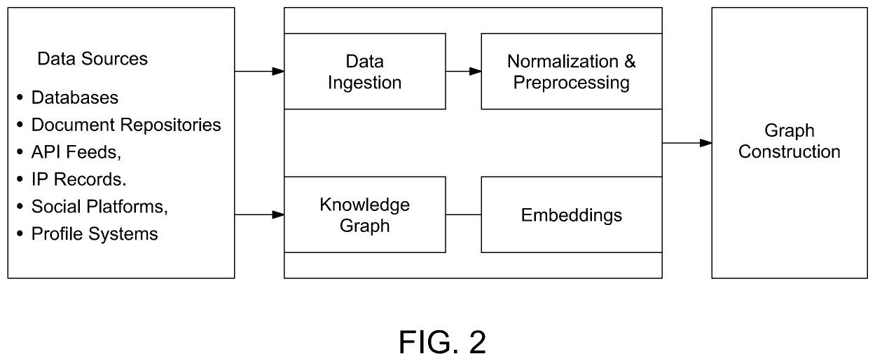

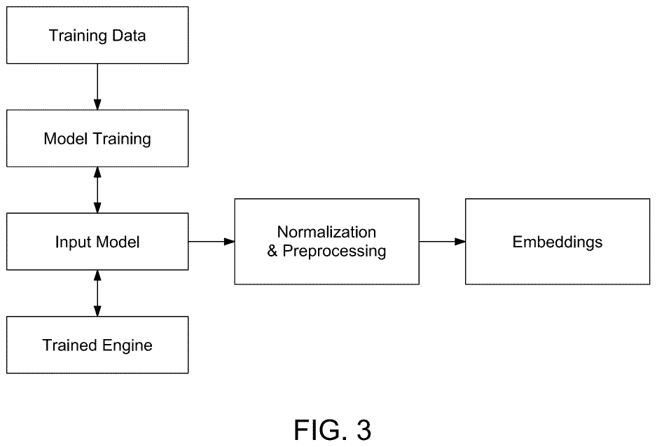

### Data Processing and Model Training (FIG. 2 & FIG. 3)

Innovation-related data may include, but is not limited to:
problem statements,
solution descriptions,
technical specifications,
intellectual property references,
readiness indicators,
metadata, and
innovator profiles.

As shown in FIG. 2, the data processing flow begins with ingestion from multiple data sources (including databases, document repositories, API feeds, IP records, social platforms, and profile systems), followed by normalization and preprocessing, knowledge graph construction, and generation of embeddings for use by the machine learning models.

As shown in FIG. 3, the machine learning model training pipeline receives training data as input, performs normalization and preprocessing on the input data, generates embeddings, and produces a trained engine as output. Model training may utilize supervised, unsupervised, semi-supervised, or reinforcement learning techniques. Labeling may be provided by users or inferred from historical interaction data. Models may be updated periodically or continuously.

### Inference and Decision Logic

During inference, the system applies trained models to evaluate similarity, relevance, and compatibility between a user-defined objective and available innovation resources. Matching may be based on similarity scores, contextual constraints, confidence thresholds, or weighted relevance metrics.

Based on matching results, the system may enable actions such as communication, licensing, collaboration, or deployment of selected innovation resources.

### Feedback and Learning Loop

User interactions with the visualization interface—including selections, refinements, communications, and outcomes—are captured as feedback signals. These signals are used to retrain models, adjust ranking logic, or update feature representations. Model versioning may be employed to track improvements over time.

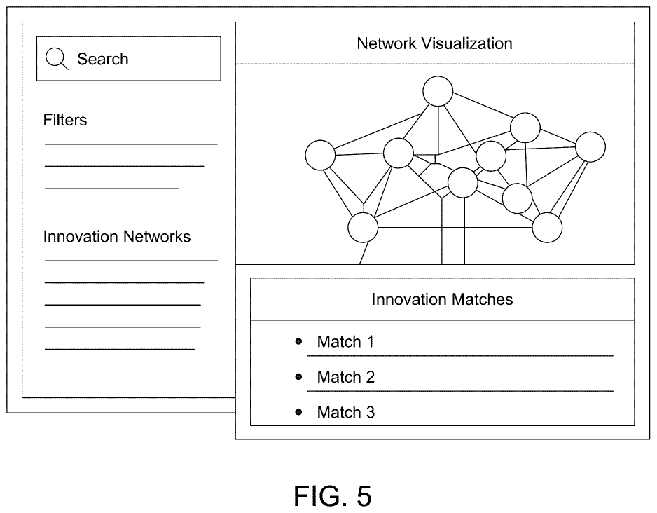

FIG. 5 illustrates an interactive user interface featuring a network visualization display, search functionality, filter options, innovation network connections, and a list of matched innovation resources presented to the user for exploration and selection.

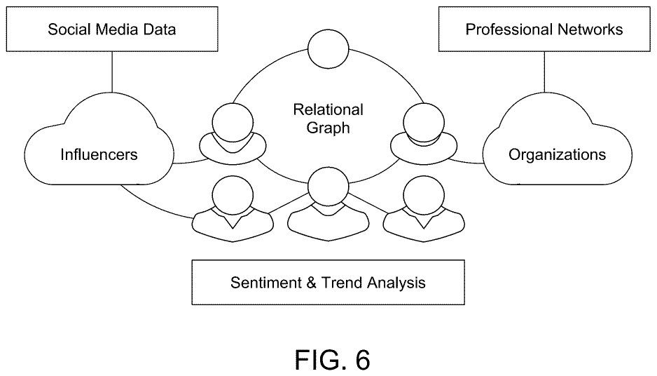

FIG. 6 illustrates a system for analyzing social media data to identify influencers, organizations, and professional network connections, with capabilities for sentiment analysis and trend analysis across these entities and their relationships to innovation resources.

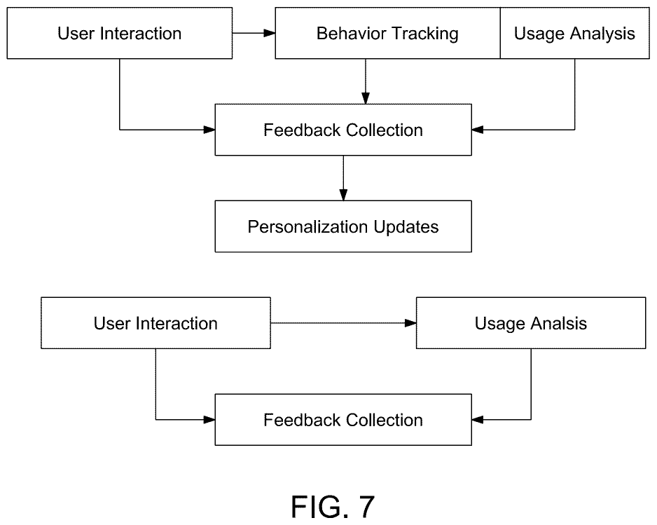

FIG. 7 illustrates a continuous feedback loop system that captures user interaction data, performs behavior tracking and usage analysis, collects user feedback, and applies personalization updates to enhance system performance and user experience.

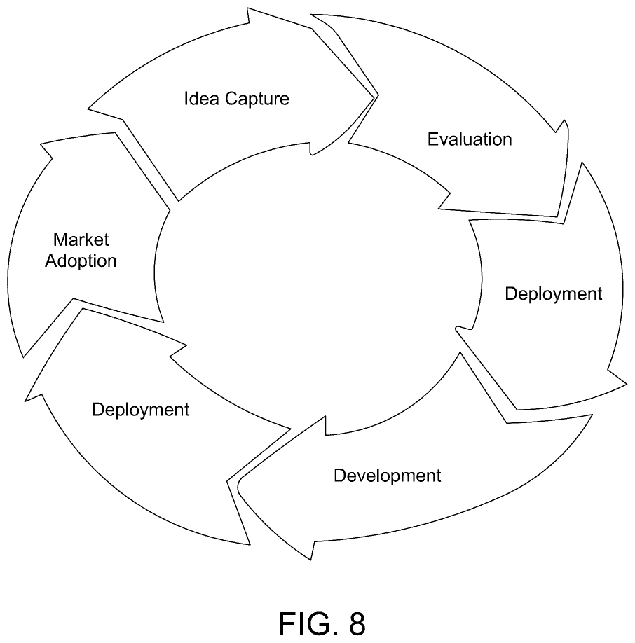

FIG. 8 illustrates an end-to-end innovation lifecycle progressing through sequential stages from idea capture, to development, to deployment, and ultimately to market adoption, demonstrating the complete journey of innovation resources within the system.

### Alternative Embodiments

The system may be deployed in cloud-based, edge-based, or hybrid environments. Models may be centralized or distributed. Rule-based logic may supplement or replace machine learning components in certain embodiments.

### Example Use Cases

Non-limiting examples include:
enterprise innovation sourcing,
public-sector challenge matching,
research commercialization,
intellectual property discovery, and
cross-industry collaboration.

Those skilled in the art will recognize that the methods and systems of the present invention have many applications, and that the present invention is not limited to the representative examples disclosed herein. Moreover, the scope of the present invention covers conventionally known variations and modifications to the system components described herein, as would be known to those skilled in the art.

What is claimed is:

1. A computer-implemented system for artificial intelligence-driven visualization and access to distributed innovation resources, comprising:
a. one or more processors;
b. one or more non-transitory memory devices storing instructions that, when executed by the one or more processors, cause the system to:
c. ingest innovation-related data from a plurality of distributed and independently managed innovation data sources, the innovation-related data comprising heterogeneous data formats;
d. normalize and encode the innovation-related data into machine-interpretable feature representations;
e. apply one or more trained artificial intelligence models to the feature representations to generate structured representations of innovation resources;
f. compare the structured representations to a user-defined innovation objective using an inference engine to generate relevance scores;
g. rank or filter the innovation resources based on the relevance scores; and
h. present, via an interactive visual interface, a dynamic visualization of the ranked innovation resources enabling user exploration and selection.

2. The system of claim 1, wherein the distributed innovation data sources include at least one of databases, application programming interfaces, document repositories, intellectual property registries, or innovator profile systems.

3. The system of claim 1, wherein the normalization and encoding includes generating vector embeddings representing semantic attributes of the innovation resources.

4. The system of claim 1, wherein the artificial intelligence models include at least one of supervised learning models, unsupervised learning models, semi-supervised learning models, or reinforcement learning models.

5. The system of claim 1, wherein the structured representations comprise graph-based data structures representing relationships among innovation resources.

6. The system of claim 1, wherein the inference engine applies weighted relevance metrics based on technical compatibility, readiness level, or contextual constraints.

7. The system of claim 1, further comprising a feedback module configured to capture user interaction data and update parameters of the artificial intelligence models.

8. The system of claim 7, wherein the feedback module triggers periodic or continuous retraining of the artificial intelligence models.

9. The system of claim 1, wherein the interactive visual interface enables dynamic filtering, clustering, or refinement of the innovation resources in real time.

10. The system of claim 1, wherein the system is deployed in a cloud-based, edge-based, distributed, or hybrid computing environment.

11. A computer-implemented method for artificial intelligence-driven visualization and access to distributed innovation resources, comprising:
a. ingesting innovation-related data from a plurality of distributed innovation data sources;
b. transforming the innovation-related data into normalized, machine-interpretable feature representations;
c. generating structured representations of innovation resources using one or more artificial intelligence models;
d. receiving a user-defined innovation objective;
e. matching the user-defined innovation objective to the structured representations using an inference engine to generate relevance scores;
f. ranking or filtering innovation resources based on the relevance scores; and
g. displaying, via an interactive visual interface, a visualization of the ranked innovation resources enabling user interaction.

12. The method of claim 11, wherein transforming the innovation-related data includes generating embeddings representing semantic similarity among innovation resources.

13. The method of claim 11, wherein generating structured representations includes clustering innovation resources based on shared attributes.

14. The method of claim 11, wherein matching the user-defined innovation objective includes computing similarity metrics between objective embeddings and innovation resource embeddings.

15. The method of claim 11, further comprising capturing user interaction data and using the interaction data as feedback to update the artificial intelligence models.

16. The method of claim 15, wherein updating the artificial intelligence models includes retraining the models using supervised or reinforcement learning techniques.

17. The method of claim 11, further comprising enabling access, communication, licensing, or deployment of a selected innovation resource.

18. The method of claim 11, wherein the visualization includes network graphs, clusters, timelines, or multidimensional plots.

19. A non-transitory computer-readable medium storing instructions that, when executed by one or more processors, cause the processors to perform a method comprising:
a. ingesting heterogeneous innovation-related data from distributed sources;
b. normalizing and encoding the data into feature representations;
c. applying artificial intelligence models to generate structured representations of innovation resources;
d. matching the structured representations to a user-defined innovation objective using an inference engine;
e. ranking the innovation resources based on relevance scores; and
f. presenting an interactive visualization enabling exploration and selection of the innovation resources.

20. The non-transitory computer-readable medium of claim 19, wherein the instructions further cause the processors to capture user feedback and update model parameters.

21. The non-transitory computer-readable medium of claim 19, wherein the artificial intelligence models are updated continuously based on interaction outcomes.

22. The non-transitory computer-readable medium of claim 19, wherein the instructions cause the processors to construct graph-based representations of innovation relationships.
